(19) United States
(12) Patent Application Publication
(10) Pub. No.: US 2007/0137625 A1
(43) Pub. Date: Jun. 21, 2007

(54) Controlling size of work machine cooling system

(76) Inventors: Steven A. Daniel, East Peoria, IL (US); Mohammad Karim, Dunlap, IL (US); George E. Donaldson, Chillicothe, IL (US); Richard L. Fulcher, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/311,331

(22) Filed: Dec. 20, 2005

(51) Int. Cl. F02M 15/00; F02B 33/00; F02B 29/04

(52) U.S. Cl. 123/542; 123/563; 60/599

(57) ABSTRACT

A work machine system is provided. The system comprises an engine including an air intake system and an exhaust system. The engine is configured to operate efficiently at a defined intake manifold temperature. A cooling system includes a cooling unit mounted at the frontal area of the work machine. The cooling unit houses a cooling component for engine intake air that is undersized relative to a cooling component designed for engine intake air to be delivered to an intake manifold at the defined intake manifold temperature. A control system is configured to operate the engine and the cooling system so that intake air is delivered to the intake manifold at a temperature higher than the defined intake manifold temperature.

### TECHNICAL FIELD

This disclosure relates to a cooling system and, more particularly, to a method and system for controlling the size of a work machine cooling system.

### BACKGROUND

Work machines, such as on-highway trucks/vehicles and off-highway machines of a wide variety, may be powered by various types of engines, such as internal combustion engines. Internal combustion engines, the various systems associated with internal combustion engines in work machines, and other components of a work machine require a cooling system to dissipate heat. The size of a cooling system may vary based on a number of factors, including the amount of heat generated by the engine and its associated systems, and other work machine components.

On-highway trucks and some off-highway work machine may have components of the cooling system located at the frontal area of the truck or other work machine. For example the cooling system may have a cooling unit designed to be accommodated at the front of a work machine, and the cooling unit may include components for cooling hydraulic oil, engine coolant, and engine charge air. The cooling unit may include one or more air movers, such as a fan or fans, which may assist the dissipation of heat from the various components of the cooling system.

Environmental and economic concerns dictate that measures be taken to reduce pollution by the byproducts of combustion in internal combustion engines and to improve fuel economy. In recent years, for example, emphasis has been placed on reducing the emission of oxides of Nitrogen (NOₓ) and particulates, in addition to improving fuel economy. For example, both improved NOₓ reduction and improved Brake Specific Fuel Consumption (BSFC) may be achieved by controlling the intake manifold temperature (IMT). Control of IMT may be accomplished with an air-to-air after cooler (ATAAC) for cooling the charge air being delivered to the engine. Various systems for recirculating engine exhaust gases back into the combustion cylinders of the engine, and devices for filtering exhaust gases to remove particulates, may be provided to reduce undesirable emissions to the environment. Adding recirculation systems for engine exhaust gases and devices for removing particulates tend to generate more heat that needs to be dissipated and, thus, an increase of the cooling system load.

Another engine design feature that has led to reduction in the creation of undesirable engine emissions is the concept of varying intake valve actuation. In essence, the intake valves of an internal combustion engine may be closed “early” during the intake stroke of a 4-cycle engine, or the intake valves may be closed “late” during the compression stroke of a 4-cycle engine. This early or late closing of the intake valve may be accompanied by the use of one or more turbochargers and/or superchargers to increase the density of the air charge entering the combustion cylinders. The turbochargers or superchargers may require cooling components to lower the temperature of the charge air that is caused by the heat of compression. Additionally, the timing during the intake or compression stroke for closing an intake valve may be varied in accordance with engine speed, load, and/or other parameters to achieve better engine efficiency, with one result being lower production of NOₓ.

These advances in engine emissions reduction tend toward generation of more heat and, thus, an increase of the cooling system load. Increasing the cooling system load ordinarily dictates an increase in the size of the cooling system. In turn, since a cooling unit and its associated components designed to dissipate unwanted heat may be placed at the front of a work machine, the result may be a requirement that the frontal area of a work machine that is occupied by the cooling unit be increased. This increase may directly or indirectly affect the sizing and location of other engine components, as well as the general design of the on-highway or off-highway work machine. Following from a greater size of the cooling unit is an accompanying increase in fan noise. It is a desirable objective that engine emissions continue to be reduced without enlarging or otherwise altering existing space requirements for the cooling system at the frontal area of a work machine, and without an increase in noise.

The disclosure of U.S. Patent Application Publication No. US 2005/0098149 A1 published May 12, 2005 ('149 publication) discusses variable intake valve closing and the recirculation of exhaust gases in the context of reducing exhaust emissions to the environment. In the system of the '149 publication, the variable valve actuating mechanism and associated controller operate to vary the closing of the intake valve from near bottom dead center to the second half of the compression stroke in a 4-cycle engine. The '149 publication also contemplates the use of an exhaust gas recirculation (EGR) system to recirculate exhaust gases back through the engine for combustion.

While the system of the '149 publication may employ advances in exhaust emissions reduction technology, such as variable valve actuation and EGR, the '149 publication does not give evidence of the recognition of the impact of these advances on the cooling system. Since the '149 publication does not discuss the impact of these advances on the cooling system, it does not give evidence of the recognition of cooling system sizing on design considerations for the frontal area of work machines. Moreover, the '149 publication does not disclose any relationship between exhaust emissions reduction and cooling system design.

This disclosure is directed toward improvements and advancements over the foregoing technology.

### SUMMARY OF THE INVENTION

In one aspect, the present disclosure is directed to a work machine system. The system comprises an engine including an air intake system and an exhaust system. The engine is configured to operate efficiently at a defined intake manifold temperature. A cooling system includes a cooling unit mounted at the frontal area of the work machine. The cooling unit houses a cooling component for engine intake air that is undersized relative to a cooling component designed for engine intake air to be delivered to an intake manifold at the defined intake manifold temperature. A control system is configured to operate the engine and the cooling system so that intake air is delivered to the intake manifold at a temperature higher than the defined intake manifold temperature.

In another aspect, the present disclosure is directed to a method of effectively handling additional heat load with the cooling system of a work machine. The method includes providing a work machine with a cooling system and an engine including an air intake system and an exhaust system, wherein the engine is configured to operate efficiently at a defined intake manifold temperature. The method also includes providing a cooling unit of the cooling system configured to be mounted at the frontal area of the work machine and having a cooling component for engine intake air that is undersized relative to a cooling component designed for engine intake air to be delivered to an intake manifold at the defined intake manifold temperature. Moreover, the method includes operating the engine and cooling system so as to deliver intake air to the intake manifold at a temperature higher than the defined intake manifold temperature.

In still another aspect, the present disclosure is directed to a work machine comprising a chassis and a frontal area. An engine is mounted on the chassis and includes an air intake system and an exhaust system. The engine is configured to operate efficiently at a defined intake manifold temperature. A cooling system is mounted on the chassis and includes a cooling unit mounted at the frontal area of the work machine. The cooling unit houses a cooling component for engine intake air that is undersized relative to a cooling component designed for engine intake air to be delivered to an intake manifold at the defined intake manifold temperature. A control system is mounted on the chassis and is configured to operate the engine and cooling system so that intake air is delivered to the intake manifold at a temperature higher than the defined intake manifold temperature.

In a further aspect, the present disclosure is directed to a method of limiting the space occupied by a cooling unit at the frontal area of a work machine. The method includes providing the work machine with an engine system including a four cycle internal combustion engine having a plurality of combustion cylinders, an air intake system, and an exhaust system. The method also includes providing the engine system with an intake valve actuation system configured to variably alter the position within one of an intake stroke and a compression stroke of the engine that an engine intake valve closes. The method further includes providing the engine system with a clean gas injection system configured to introduce filtered engine exhaust gases into the air intake system. In addition, the method includes providing at least one compressor unit within the air intake system to compress intake air, including engine exhaust gases that are introduced into the air intake system. The method also includes determining the size of an air-to-air cooling component sufficient to cool intake air, including engine exhaust gases that are introduced into the air intake system, to a defined intake manifold temperature. The method further includes selecting an air-to-air cooling component substantially less in size than the determined size and, concurrently, increasing the intake manifold temperature above the defined temperature. Moreover, the method includes installing the selected air-to-air cooling component at the frontal area of the work machine and within the air intake system.

In yet another aspect, the present disclosure is directed to a method of implementing an engine system to meet stricter emissions targets. The method includes identifying an existing work machine type having an existing engine system meeting existing emissions targets, having an existing cooling unit configured to handle the cooling load generated by the work machine and engine system, and having an existing defined machine frontal area design for the cooling unit. The method also includes determining the operating intake manifold temperature of the existing engine system. The method further includes identifying emissions targets that are stricter than the existing emissions targets. Further, the method includes redesigning the engine system to include technology configured to enable the engine system to meet the stricter emissions targets, wherein the redesigned engine system is characterized by an increased heat load relative to the existing engine system. The method also includes increasing the operating intake manifold temperature of the redesigned engine system above that determined for the existing engine system. In addition, the method includes maintaining the existing defined machine frontal area design for components of the cooling system. Moreover, the method includes implementing the redesigned engine system on a work machine type whereby the redesigned engine system meets the stricter emissions targets, and wherein the cooling load generated by the work machine type and the redesigned engine system can be handled by the cooling unit with the existing defined machine frontal area design.

In yet a further aspect, the present disclosure is directed to a method of satisfying new engine emissions requirements for a work machine engine system that are stricter than previous engine emissions requirements without increasing the frontal area of the work machine occupied by components of the work machine cooling system. The method includes designing an engine system capable of satisfying the new engine emissions requirements when operating with an identified intake manifold temperature, the engine system including an air intake system, an exhaust system, at least one turbocharger, an intake valve actuation component, and a clean gas injection system. The method also includes providing the work machine with the designed engine system. Additionally, the method includes selecting a cooling unit sized for the frontal area of a work machine having an engine system that is not designed to satisfy the new engine emissions requirements, but is capable of satisfying the previous engine emissions requirements when operating with an intake manifold temperature substantially less than the identified intake manifold temperature. Further, the method includes providing the work machine with the selected cooling unit mounted at the front of the work machine. Moreover, the method includes operating the work machine with the provided engine and the provided cooling unit and operating the engine system with the identified intake manifold temperature.

### BRIEF DESCRIPTION OF THE DRAWINGS

FIG. 1 is a diagrammatic illustration of a work machine provided with a cooling system according to a disclosed embodiment;

FIG. 2A is a view showing an embodiment of a cooling unit for a cooling system of a work machine;

FIG. 2B is another view of an embodiment of a cooling unit for a cooling system of a work machine; and

FIG. 3 is a high level flow chart illustrating aspects of the disclosure.

### DETAILED DESCRIPTION

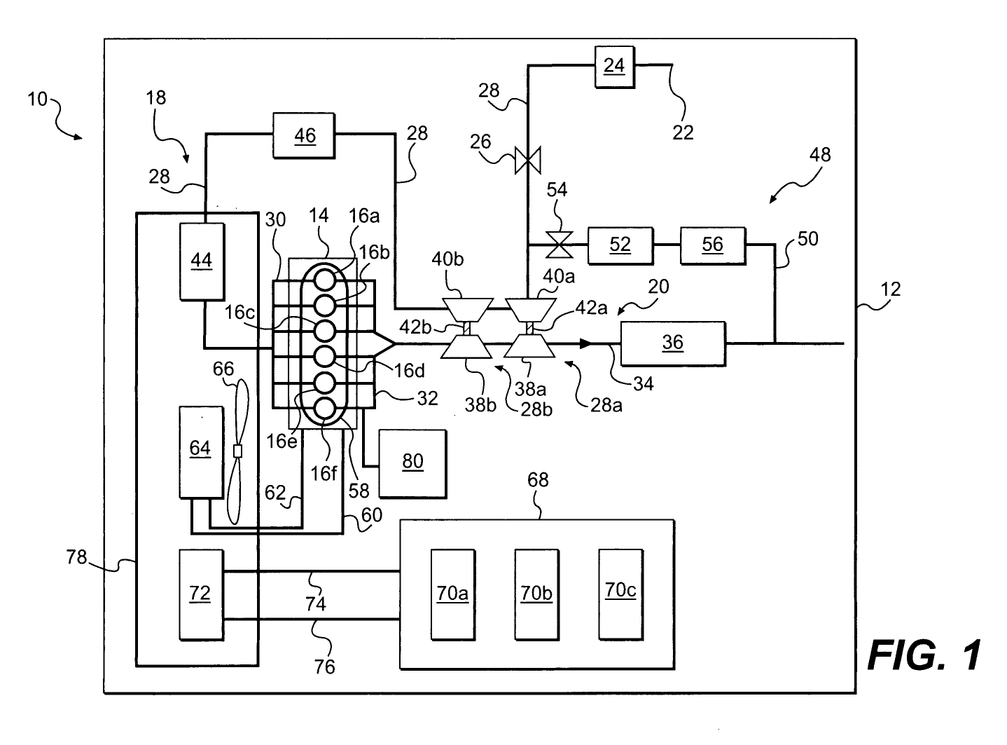

FIG. 1 diagrammatically illustrates an exemplary work machine 10 that embodies an engine system and a cooling system and is provided with technology tending to reduce the emission of engine exhaust related pollutants to the environment. The rectangular outline 12 represents the chassis of the work machine 10. Internal combustion engine 14, for example a diesel engine, is mounted on chassis 12. In the illustrative example, engine 14 is shown with six combustion cylinders 16a-16f for generating power, each provided with a piston, one or more intake valves, one or more exhaust valves, and other components (not shown) known to those having skill in the art. Engine 14 may be provided with an air intake system 18 and an exhaust system 20.

Air intake system 18 may include various components including, for example, intake opening 22, air filter 24, throttle valve 26, intake conduit 28, and intake manifold 30. Exhaust system 20 may include various components including, for example, exhaust manifold 32, exhaust conduit 34, and aftertreatment module 36, which may be a particulate filter with or without a catalytic component. Components with parts included in both the air intake system 18 and the exhaust system 20 are turbochargers 28a and 28b. In this embodiment two turbochargers are illustrated, but it will be understood that the number of turbochargers could be one or more than two and still fall within the scope of this disclosure. Furthermore, expedients other than turbochargers, such as an engine driven supercharger or superchargers, may be employed to compress or otherwise increase the density of charge air within the air intake system 18.

Turbocharger 28a may include a turbine section 38a in exhaust system 20 driven by exhaust gases and a compressor section 40a for compressing air in air intake system 18. Turbocharger 28b may include a turbine section 38b in exhaust system 20 driven by exhaust gases and a compressor section 40b for compressing air delivered from compressor section 40a. Each turbine section 38a, 38b drives its respective compressor section 40a, 40b via suitable drive connections such as drive shafts 42a, 42b. Thus, in the embodiment illustrated in FIG. 1, dual turbochargers 28a, 28b process intake air through two stages of compression. The compressed air delivered from the dual turbochargers 28a, 28b has an elevated temperature relative to the air taken in at intake opening 22. For example, the intake air exiting the downstream turbocharger 28b may significantly exceed 200° C.

The considerable heat contained in intake air delivered from turbochargers 28a, 28b may require significant cooling before delivery to combustion cylinders 16a-16f. An air-to-air cooling component, such as an air-to-air after cooler (ATAAC) 44, may be provided downstream of the compressor section 40b and upstream of the intake manifold 30. If a suitable intake manifold temperature (IMT), such as approximately 49° C., is to be maintained, cooling requirements dictate an ATAAC 44 of significant size to bring the temperature of the air exiting compressor section 28b (as much as or more than 200° C.) down to the desired IMT. Cooling requirements for the ATAAC 44 may be mitigated to some extent by the optional provision of an additional cooling unit, such as pre-cooler 46, upstream of the ATAAC 44.

An auxiliary system, such as clean gas injection (CGI) system 48 may be provided to introduce a portion of the exhaust gases from the exhaust system 20 into air intake system 18. CGI system 48 may include a suitable conduit 50. Conduit 50 may connect to exhaust conduit 34 at a location downstream of aftertreatment module 36 and may connect to the intake conduit 28 at a point downstream of air filter 24 and upstream of compressor section 40a of turbocharger 28a. CGI system 48 may include a suitable unit such as mass flow sensor 52 to control a suitable valve such as CGI valve 54 in order to provide control of the amount of exhaust gases to be reintroduced into the air intake system 18. The elevated temperature of exhaust gases entering CGI system 48 may be mitigated by a cooling component such as CGI cooler 56.

To dissipate the relatively large amount of heat generated directly in the engine 14 by the combustion process in combustion cylinders 16a-16f, engine 14 may be provided with a system of generally designated passageways 58. Passageways 58 may connect, via suitable lines 60, 62, for example, to a radiator 64. A suitable liquid coolant may circulate within passageways 58, lines 60, 62, and radiator 64 whereby heat from engine 14 may be transferred to radiator 64. In addition coolant may circulate through suitable lines (not shown) between radiator 64 and CGI cooler 56. Moreover, where pre-cooler 46 is present, it may likewise deliver the heat it extracts from intake air to coolant circulating through suitable lines (not shown) and connected to radiator 64. As is known in the art, the drive transmission for work machine 10 may likewise be cooled by suitable connection to radiator 64. Radiator 64 may be suitably mounted at the front of work machine 10 where dissipation of heat from the radiator to ambient may be facilitated by radiation with or without the aid of a suitable fan 66, such as a motor driven fan, and/or movement of the work machine 10.

Work machine 10, in a manner otherwise conventional for work machines generally, may be provided with a hydraulic system 68 which may comprise various hydraulically operated components 70a, 70b, 70c, for example. Hydraulic system 68 may be provided with a suitable reservoir and lines (not shown) for hydraulic fluid. As is known in the art, operation of hydraulic equipment, such as components 70a, 70b, 70c, generates heat in the hydraulic fluid which must be dissipated to ensure proper operation and maintenance of the hydraulic system 68. Accordingly, hydraulic system 68 may be provided with a suitable hydraulic oil cooler 72. Hydraulic fluid may circulate between hydraulic system 68 and hydraulic oil cooler 72 via suitable lines 74, 76 whereby heat contained in the hydraulic fluid may be dissipated to ambient from the hydraulic oil cooler 72.

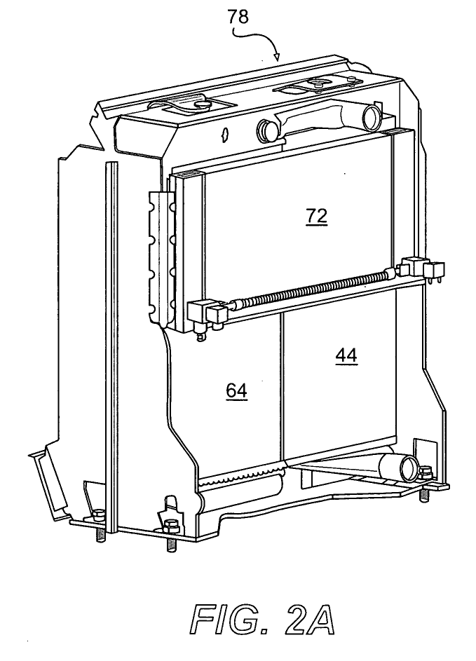

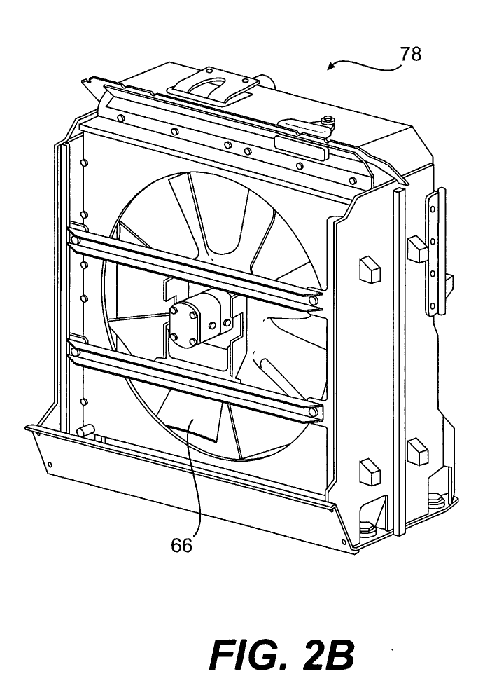

The ATAAC 44, radiator 64, and hydraulic oil cooler 72 may be suitably integrated into a cooling unit 78 and may be mounted at the frontal area of work machine 10. Cooling unit 78 must be taken into account in the overall design of the work machine frontal area. FIGS. 2A and 2B illustrate an exemplary embodiment of how a cooling unit 78 may be configured. Referring to FIG. 2A, viewed from the front of cooling unit 78, radiator 64 may be arranged at the bottom left portion of the cooling unit 78 and the ATAAC 44 may be located beside it at the bottom right of the cooling unit 78. The top portion of cooling unit 78 may be occupied by hydraulic oil cooler 72. Referring now to FIG. 2B, viewed from the rear of cooling unit 78, fan 66 may be a motor driven fan arranged to encompass substantially the entire area behind radiator 64, ATAAC 44, and hydraulic oil cooler 72 and configured to forcefully direct air over the surfaces of radiator 64, ATAAC 44, and hydraulic oil cooler 72 in order to dissipate heat to ambient. Obviously, the configuration and arrangement of the components of cooling unit 78 may be different from that shown in the example of FIGS. 2A and 2B.

Returning to FIG. 1, each combustion cylinder 16a-16f of engine 14 may contain one or more intake valves (not shown) and one or more exhaust valves (not shown), in a manner known to those skilled in the art. The intake valves may be controlled by an intake valve actuation (IVA) system 80, shown diagrammatically associated with engine 14. The IVA system 80 operates in known manner to suitably and variably time the opening and closing of the intake valve or valves in accordance with engine speed, load, and other design parameters to achieve fuel economy, efficient power generation, and reduction in the emission of NOₓ and other undesirable by-products of combustion in internal combustion engines. Implementation of IVA system 80 may be accompanied by increased compression of charge air prior to its introduction into combustion cylinders 16a-16f. This increased compression may be facilitated by dual turbochargers 28a, 28b.

Internal combustion engine 14 and the various systems associated therewith are suitably controlled by a control system (not shown), such as a programmed electronic control system, that is mounted on the chassis 12 and includes sensors and associated circuitry to assure that the various systems perform in the intended manner. The cooling system associated with engine 14 and work machine 10 likewise is suitably controlled to ensure temperatures remain within design limits.

### INDUSTRIAL APPLICABILITY

The disclosed cooling system may be employed on any work machine type, either of the on-highway or off-highway type, to accommodate the need for cooling an internal combustion engine that is designed to meet increased emission control targets that may be set by government and/or industry regulation without increasing the frontal area of the work machine that may be needed for components of the cooling system. The cooling system is designed to effectively and efficiently handle the cooling load for an internal combustion engine provided with one or more turbochargers and/or superchargers, an intake valve actuation system, and a system for recirculating at least a portion of filtered exhaust gases back to the engine air intake system, as well as for other work machine components.

Reference will initially be made to the embodiment illustrated in FIG. 1 to describe, by way of example, the applicability of the disclosed method. Without CGI system 48 and the IVA system 80, engine 14 may have a design IMT of approximately 49° C., for example, in order to effectively and efficiently meet existing emissions targets, such as for NOₓ and particulates, and maintain an economical brake specific fuel consumption (BSFC). Cooling unit 78 at the front of a work machine 10 operating with engine 14 may be designed to occupy a determined frontal area of the work machine 10 sufficient to permit dissipation of enough heat to permit the IMT to be maintained at the exemplary design IMT of approximately 49° C.

In order to satisfy increasing exhaust emission targets, requirements, or standards, for example to reduce NOₓ and particulate emissions, IVA system 80 and CGI system 48 may be implemented. Implementation of IVA system 80 and CGI system 48, however, may affect the cooling load on the cooling system. With implementation of IVA system 80 comes the need for increased charge air compression before introduction of the charge air into the combustion cylinders 16a-16f, and this increased compression is unavoidably accompanied by an increase in charge air temperature. Given the temperature of engine exhaust, CGI system 48 also implicates an increase in temperature. Ordinarily, all other parameters remaining unchanged, this would require that the cooling unit 78 be increased in size with concomitant increase in the frontal area of the work machine occupied by the cooling unit 78, coupled with an increase in noise due to increased fan size. Counter-intuitively, a number of factors, working together, permit implementation of IVA system 80 and CGI system 48 without an increased frontal area occupied by cooling unit 78.

Implementation of CGI system 48 without implementation of IVA system 80 substantially increases cooling load due to the hot exhaust gases injected into the air intake system 28. Part of this cooling load is borne by CGI cooler 56 and, in turn, by radiator 64. Another part of this cooing load is borne by the ATAAC 44, and pre-cooler 46 when present, in view of the still elevated temperature of the gases injected from the CGI system 48 into air intake system 28. With implementation of CGI system 48 without IVA system 80, and with maintaining the exemplary approximately 49° C. IMT, an increase in work machine frontal area occupied by cooling unit 78 seemingly could hardly be avoided. However, the addition of IVA system 80 coupled with CGI system 48 unexpectedly offers an opportunity to achieve the advantages of IVA and CGI without changing the size of cooling unit 78 and increasing the work machine frontal area it occupies.

IVA system 80 will permit a higher than expected IMT while still lowering NOₓ production below target levels. IVA, combined with CGI, make NOₓ and BSFC less sensitive to IMT. As a result, the design permissible IMT can be raised from the exemplary approximately 49° C. up to approximately 60° C. Given that the temperature of the air exiting turbocharger 28b may significantly exceed approximately 200° C., increasing the permissible IMT from 49° C. to 60° C., for example, significantly decreases the temperature differential that is to be achieved by the ATAAC 44 and concomitantly significantly increases the cooling efficiency of the ATAAC 44. Because the ultimate temperature to which the intake air must be lowered by the ATAAC 44 is substantially higher (60° C. rather than 49° C. in this example), the ATAAC 44 is substantially more efficient. This increase in efficiency permits the size of the ATAAC 44 to remain the same as that otherwise utilized for a design IMT without IVA and CGI.

The load imposed on radiator 64 by CGI cooler 56 and optional pre-cooler 46 is relatively nominal as compared to that otherwise borne by ATAAC 44 when required to maintain an exemplary design IMT of 49° C. Additionally, implementation of IVA reduces the engine heat transferred to the coolant in passageways 58, and thus to radiator 64. Radiator load accordingly does not implicate significant redesign of either the cooling system or work machine. Raising the design IMT to an exemplary approximately 60° C., and thus increasing the efficiency of the ATAAC 44 so that it need not be increased in size, permits the use of the same cooling unit 78 implemented prior to the implementation of IVA and CGI. Accordingly, potential redesign of the frontal area of work machines with the accompanying increased fan noise may be avoided.

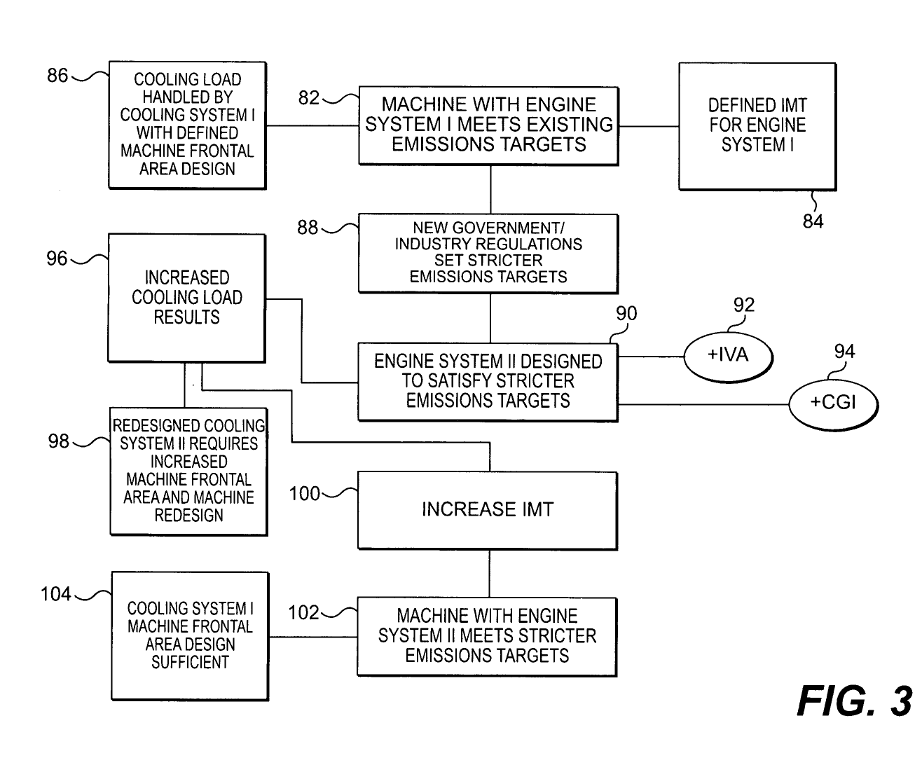

FIG. 3 is a flow chart illustrating concepts and steps involved in the disclosed method and system and permitting an engine system and work machine design meeting stricter emissions targets while maintaining existing work machine frontal area design. At 82, an existing work machine has been designed with an engine system, designated engine system I for convenience, that meets current, existing emissions targets. The existing work machine, at 84, has a defined IMT for engine system I and, at 86, a cooling system, designated cooling system I for convenience, capable of handling the work machine cooling system load with the frontal area design of the existing work machine. From time to time, at 88, government and/or industry regulations may be announced or promulgated setting stricter emissions targets than those the existing work machine engine system I was designed to meet.

Stricter emissions targets may require, at 90, design of an engine system, designated engine system II for convenience, capable of meeting those targets. As indicated at 92 and 94, engine system II may be designed with an IVA component and a CGI system. Design of engine system II with IVA and CGI may significantly increase the cooling load, at 96, produced by the engine system II and the work machine that must be handled by cooling system I. Accordingly, at 98, the cooling system may be redesigned as cooling system II which, because increased heat must be dissipated to ambient, requires increased machine frontal area for a cooling unit housing a cooling component for engine intake air in order to maintain the defined IMT that was recognized for engine system I. Because a number of factors affect machine system frontal area design, significant machine redesign may be necessary to accommodate the increased machine frontal area to be occupied by components of cooling system II.

Increasing IMT for the designed engine system II above that defined for engine system I, at 100, is the unexpected and counter-intuitive way to avoid cooling system redesign to accommodate a larger cooling component for engine intake air with its resulting larger cooling unit occupying additional machine frontal area, and implicating significant machine redesign. The engine design with IVA and CGI makes NOₓ and BSFC less sensitive to IMT. As a result, stricter emissions targets, at 102, are met, with the additional benefit of fuel economy. Because the IMT is substantially higher than with the existing work machine with engine system I, the work machine frontal area design employed with cooling system I, at 104, is sufficient to handle the heat load. The cooling component for engine intake air, and the cooling unit that houses it, may remain the same size as that employed with engine system I. In effect, the cooling component for engine intake air may be undersized relative to a cooling component designed for engine intake air to be delivered to the intake manifold at the defined intake manifold temperature. Because the design IMT is elevated substantially from the prior design IMT, ATAAC 44 may remain substantially unchanged from that utilized prior to implementation of IVA and CGI.

While examples of increase in IMT from 49° C. to 60° C. have been set forth to illustrate the disclosed method and system, it is contemplated that other temperature differentials may be applicable within the scope of this disclosure. The particular existing IMT and the IMT of an engine system redesigned in accordance with this disclosure may vary. More significant is the recognition of the implications on machine cooling system frontal area design in raising the IMT when implementing emissions controls that address stricter emissions targets.

It will be apparent to those skilled in the art that various modifications and variations can be made to the disclosed embodiments without departing from the scope of this disclosure. Other embodiments will become apparent to those skilled in the art from consideration of the specification and practice of the disclosed embodiments. It is intended that the specification and examples be considered as exemplary only with the true scope of protection being indicated by the following claims.

What is claimed is:

1. A work machine system, comprising:
an engine including an air intake system and an exhaust system, the engine configured to operate efficiently at a defined intake manifold temperature;
a cooling system including a cooling unit mounted at the frontal area of the work machine, the cooling unit housing a cooling component for engine intake air that is undersized relative to a cooling component designed for engine intake air to be delivered to an intake manifold at the defined intake manifold temperature;
a control system configured to operate the engine and the cooling system so that intake air is delivered to the intake manifold at a temperature higher than the defined intake manifold temperature.

2. The system of claim 1, wherein the engine includes an intake valve actuation system configured to variably alter the position within a compression stroke of the engine that an engine intake valve closes.

3. The system of claim 1, wherein the engine includes a clean gas injection system configured to introduce exhaust gases from the exhaust system into the air intake system.

4. The system of claim 3, wherein the cooling unit includes an air-to-air cooling component mounted in the air intake system, configured to cool intake air.

5. The system of claim 4, further including a pre-cooler in the air intake system upstream of the air-to-air cooling component.

6. The system of claim 1, wherein the cooling unit houses a cooling component for a work machine hydraulic system, a radiator, and an air to air after cooler.

7. The system of claim 1, including dual turbochargers in the air intake system.

8. A method of effectively handling additional heat load with the cooling system of a work machine, comprising:
providing a work machine with a cooling system and an engine including an air intake system and an exhaust system, wherein the engine is configured to operate efficiently at a defined intake manifold temperature;
providing a cooling unit of the cooling system configured to be mounted at the frontal area of the work machine and having a cooling component for engine intake air that is undersized relative to a cooling component designed for engine intake air to be delivered to an intake manifold at the defined intake manifold temperature; and
operating the engine and cooling system so as to deliver intake air to the intake manifold at a temperature higher than the defined intake manifold temperature.

9. The method of claim 8, wherein providing a work machine includes providing an engine with an intake valve actuation system configured to variably alter the position within a compression stroke of the engine that an engine intake valve closes.

10. The method of claim 8, wherein providing a work machine includes providing a clean gas injection system to introduce exhaust gases from the exhaust system into the air intake system.

11. The method of claim 10, wherein providing a cooing unit includes providing a cooling unit having an air-to-air cooling component mounted in the air intake system, configured to cool intake air.

12. The method of claim 8, wherein providing a cooling unit includes providing a cooling unit that houses a cooling component for a work machine hydraulic system, a radiator, and an air to air after cooler.

13. A work machine, comprising:
a chassis and a frontal area;
an engine mounted on the chassis and including an air intake system and an exhaust system, the engine configured to operate efficiently at a defined intake manifold temperature;
a cooling system mounted on the chassis and including a cooling unit mounted at the frontal area of the work machine, the cooling unit housing a cooling component for engine intake air that is undersized relative to a cooling component designed for engine intake air to be delivered to an intake manifold at the defined intake manifold temperature;
a control system mounted on the chassis and configured to operate the engine and cooling system so that intake air is delivered to the intake manifold at a temperature higher than the defined intake manifold temperature.

14. The work machine of claim 13, wherein the engine includes an intake valve actuation system configured to variably alter the position within a compression stroke of the engine that an engine intake valve closes.

15. The work machine of claim 13, wherein the engine includes a clean gas injection system configured to introduce exhaust gases from the exhaust system into the air intake system.

16. The work machine of claim 15, wherein the cooling unit includes an air-to-air cooling component mounted in the air intake system, configured to cool intake air.

17. The work machine of claim 16, further including a pre-cooler in the air intake system upstream of the air-to-air cooling component.

18. The work machine of claim 13, wherein the cooling unit houses a cooling component for a work machine hydraulic system, a radiator, and an air to air after cooler.

19. The work machine of claim 13, including dual turbochargers in the air intake system.

20. A method of limiting the space occupied by a cooling unit at the frontal area of a work machine, comprising:
providing the work machine with an engine system including a four cycle internal combustion engine having a plurality of combustion cylinders, an air intake system, and an exhaust system;
providing the engine system with an intake valve actuation system configured to variably alter the position within one of an intake stroke and a compression stroke of the engine that an engine intake valve closes;
providing the engine system with a clean gas injection system configured to introduce filtered engine exhaust gases into the air intake system;
providing at least one compressor unit within the air intake system to compress intake air, including engine exhaust gases that are introduced into the air intake system;
determining the size of an air-to-air cooling component sufficient to cool intake air, including engine exhaust gases that are introduced into the air intake system, to a defined intake manifold temperature;
selecting an air-to-air cooling component substantially less in size than the determined size and, concurrently, increasing the intake manifold temperature above the defined temperature; and
installing the selected air-to-air cooling component at the frontal area of the work machine and within the air intake system.

21. The method of claim 20, including mounting a cooling unit at the front of the work machine and housing within the cooling unit:
a) a cooling component for hydraulic fluid of a work machine hydraulic system;
b) a radiator configured to deliver the heat load from components mounted on the work machine; and
c) the selected air-to-air cooling unit.

22. The method of claim 21, wherein providing the engine system with a clean gas injection system includes providing a cooling component for the clean gas injection system and delivering the heat load from the cooling component to the radiator.

23. The method of claim 22, including providing a pre-cooler in the air intake system upstream of the air-to-air cooling unit and delivering the heat load from the pre-cooler to the radiator.

24. The method of claim 20, wherein providing at least one compressor unit within the air intake system includes providing first and second turbochargers to compress the intake air.

25. A method of implementing an engine system to meet stricter emissions targets, comprising:
identifying an existing work machine type having an existing engine system meeting existing emissions targets, having an existing cooling unit configured to handle the cooling load generated by the work machine and engine system, and having an existing defined machine frontal area design for the cooling unit;
determining the operating intake manifold temperature of the existing engine system;
identifying emissions targets that are stricter than the existing emissions targets;
redesigning the engine system to include technology configured to enable the engine system to meet the stricter emissions targets, wherein the redesigned engine system is characterized by an increased heat load relative to the existing engine system;
increasing the operating intake manifold temperature of the redesigned engine system above that determined for the existing engine system;
maintaining the existing defined machine frontal area design for components of the cooling system; and
implementing the redesigned engine system on a work machine type;
whereby the redesigned engine system meets the stricter emissions targets, and wherein the cooling load generated by the work machine type and the redesigned engine system can be handled by the cooling unit with the existing defined machine frontal area design.

26. The method of claim 25, wherein redesigning the engine system to include technology configured to enable the engine system to meet the stricter emissions targets includes providing an intake valve actuation system configured to variably alter the position within one of an intake stroke and a compression stroke of the engine that an engine intake valve closes.

27. The method of claim 26, further including providing a clean gas injection system for introducing filtered exhaust gases into an air intake system for the engine.

28. The method of claim 27, further including providing the clean gas injection system with a cooling component.

29. The method of claim 25, wherein implementing the redesigned engine system includes installing dual turbochargers in an air intake system for the engine system.

30. The method of claim 25, wherein redesigning the engine system includes installing an air-to-air after cooler in an air intake system for the engine that is the same size as an air-to-air after cooler installed in the existing engine system.

31. The method of claim 25, further including installing a pre-cooler in the air intake system upstream of the air-to-air after cooler.

32. The method of claim 25, wherein maintaining the existing defined machine frontal area design for components of the cooling system includes maintaining a cooling unit that houses:
a) an air-to-air after cooler configured to cool intake air;
b) a radiator configured to deliver the heat load from components mounted on the work machine; and
c) a cooling component for hydraulic fluid of a work machine hydraulic system.

33. A method of satisfying new engine emissions requirements for a work machine engine system that are stricter than previous engine emissions requirements without increasing the frontal area of the work machine occupied by components of the work machine cooling system, comprising:
designing an engine system capable of satisfying the new engine emissions requirements when operating with an identified intake manifold temperature, the engine system including an air intake system, an exhaust system, at least one turbocharger, an intake valve actuation component, and a clean gas injection system;
providing the work machine with the designed engine system;
selecting a cooling unit sized for the frontal area of a work machine having an engine system that is not designed to satisfy the new engine emissions requirements, but is capable of satisfying the previous engine emissions requirements when operating with an intake manifold temperature substantially less than the identified intake manifold temperature;
providing the work machine with the selected cooling unit mounted at the front of the work machine; and
operating the work machine with the provided engine and the provided cooling unit and operating the engine system with the identified intake manifold temperature.
